(19) United States
(12) Patent Application Publication
(10) Pub. No.: US 2016/0070455 A1
(43) Pub. Date: Mar. 10, 2016

(54) TOGGLE GRAPHIC OBJECT

(71) Applicant: International Business Machines Corporation, Armonk, NY (US)

(72) Inventors: Colin S. Dawson, Tucson, AZ (US); Brenton Elmore, Tucson, AZ (US)

(21) Appl. No.: 14/482,916

(22) Filed: Sep. 10, 2014

(51) Int. Cl. G06F 3/0484; G06F 3/0488; G06F 3/0481; G06F 3/0486

(52) U.S. Cl. CPC G06F 3/04847; G06F 3/0486; G06F 3/04883; G06F 3/04886; G06F 3/04812

(57) ABSTRACT

A toggle object is displayed upon a GUI and enables or disables functionality of a data handling system. The toggle object includes a toggle button movable between an active position and an inactive position within a sliding section barrier. The user engages the toggle button and makes a multi stage manipulation indicative of the user's intent to enable or disable associated functionality. Subsequent to the user disengaging the toggle button, functionality is enabled or disabled. Since the multi stage manipulation is indicative of the user's intent, the GUI does not display confirmation prompts thus improving the GUI user experience.

### FIELD OF THE INVENTION

Embodiments of present invention generally relate to the field of graphical user interfaces and, more specifically, relate to a system to allow for a graphical user interface implementing a toggle graphic object.

### DESCRIPTION OF THE RELATED ART

A graphical user interface (GUI) is an interface that allows users to interact with electronic devices. The use of GUIs is widespread. For example, GUIs are used in computers, tablet computers, mobile phones, portable media players, gaming devices, household appliances, cash machines, and office equipment to display various software applications. Software applications may include images and text that may be displayed via GUIs.

Improving usability of GUIs is an ongoing effort. GUIs are becoming increasing complex and include numerous text objects and image objects that which the user may interact. A positive user experience of a GUI is at risk if the text objects and image objects are arranged such that the user may make unintentional selections.

One way that traditional GUIs ensure intentional selections of image objects or text objects is to display a conformation prompt subsequent to the user making a selection. For example, a popup prompt may be displayed after a user selects an image object asking the user to confirm that he or she wants a function to be performed that is tied to the selected image object.

Another way of preventing accidental selections within a GUI is to apply an edit lock to a GUI that prevents selections or changes to input areas in a portion or an entire page of the GUI. In order to make a change, the user has to identify and deactivate the edit lock before they can make a desired selection or change.

Such known schemes of preventing unintentional selections generally impose a penalty that increases time-on-task and complexity of the interface by requiring the user to read and respond or act more times than is actually needed. Such overhead decrease the usability of the GUI by making it more difficult to use, less efficient by virtue of e.g. increased clicks, adds cognitive processing load by causing the user to have to take extra steps, and/or causes the user to have to examine and find secondary controls in the interface that allow the primary controls to be actionable.

### SUMMARY

In an embodiment of the present invention, a method for enabling or disabling data handling system functionality controlled via a GUI includes receiving a user engagement capture of a toggle object displayed upon the GUI, receiving a multiple stage user manipulation of the toggle object indicative of the users intent to enable or disable associated data handling system functionality, and enabling or disabling associated data handing system.

In another embodiment of the present invention, a computer program product for enabling or disabling data handling system functionality controlled via a GUI includes a computer readable storage medium having program instructions embodied therewith readable by a computer to cause the computer to receive a user engagement capture of a toggle object displayed upon the GUI, receive a multiple stage user manipulation of the toggle object indicative of the users intent to enable or disable associated data handling system functionality, and enable or disable functionality associated data handing system.

In another embodiment of the present invention, a GUI utilized to enable or disable functionality of a data handling system includes a toggle object. The toggle object includes a toggle button movable between an active position and an inactive position within a sliding section barrier if the GUI receives a engagement capture of the toggle button, receives a multiple stage user manipulation of the toggle button indicative of the users intent to enable or disable associated functionality, and receives a engagement release of the toggle button to enable or disable functionality of the data handing system.

These and other embodiments, features, aspects, and advantages will become better understood with reference to the following description, appended claims, and accompanying drawings.

### BRIEF DESCRIPTION OF THE DRAWINGS

FIG. 1 illustrates components and an interconnection topology for an information handling system that may utilize or enable one or more embodiments the present invention.

FIG. 2 and FIG. 3 illustrate exemplary GUI types according to embodiments of the present invention.

FIG. 4 illustrates an exemplary GUI utilizing a user selection confirmation prompt.

FIG. 5A-FIG. 5I illustrate exemplary toggle objects, according to various embodiments of the present invention.

FIG. 6 illustrates an exemplary GUI utilizing a toggle graphic object, according to various embodiments of the present invention.

FIG. 7 illustrates a toggle graphic object processing method, according to various embodiments of the present invention.

### DETAILED DESCRIPTION

Embodiments related to a toggle object utilized by a GUI. The toggle object may include a binary state to enable or disable application and/or data handling system functionality. The toggle object may change states by the user making a multi-step manipulation indicative of the user's intent. The toggle object decreases time-on-task and simplifies the GUI by reducing the number of user interactions necessary to implement functions according to the user's intent. In this way, user experience of a GUI utilizing a toggle graphic object is improved.

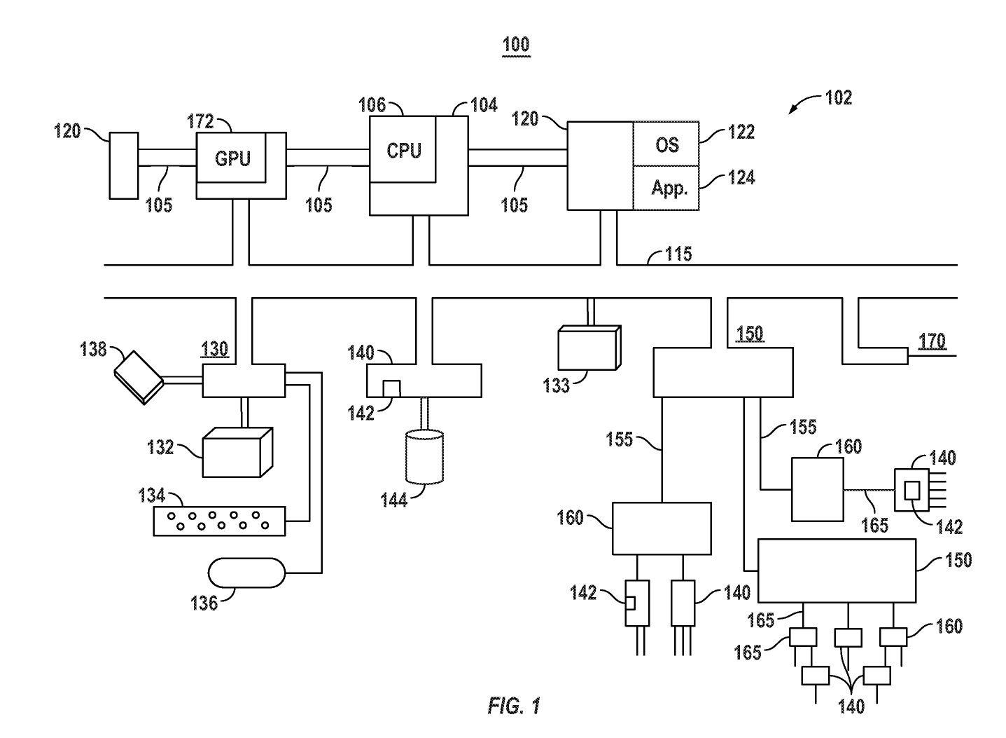

FIG. 1 illustrates components and an interconnection topology for an information handling system, for example a computer system 100 that may utilize or enable one or more embodiments the present invention. Computer system 100 may comprise a host 102 having a host processor complex 104 connected to a memory 120 by an internal bus 105 and/or a host system bus 115. In certain embodiments, host 102 may also include a graphics processor complex 170 connected to memory 120 by the internal bus 105 and/or the host system bus 115. In various embodiments, graphics processor complex 170 may be included in or may be distinct from host processor complex 104.

The host processor complex 104 has at least one general-purpose programmable processor unit (CPU) 106 that may execute program instructions stored in main memory 120. Although a single CPU 106 is shown in FIG. 1, it should be understood that a processor complex 104 may have multiple CPUs 106. Graphics processor complex 170 has at least one general-purpose programmable graphics processor unit (GPU) 172 that builds images (e.g. a GUI) for output to a display 132. CPU 106 working in conjunction with applications 124 sends information about an image to GPU 172. GPU 172 determines how to manipulate pixels on e.g. display 132 or touch screen 133 to create a display image or user interface. Ultimately, the processing complex communicates that information to display 132 or touch screen 133 and the image (e.g. GUI, etc.) is displayed to a user. CPU 106 and GPU 172 may be discrete components as shown in FIG. 1 or may be integrated into a single component.

Memory 120 or a portion of memory 120 may be included within the host processor complex 104 and/or graphics processor complex 170 or connected to it via an internal bus system 105 or via a host system bus 115. Memory 120 may be for example a random access memory for storing data and/or program instructions. Though memory 120 is shown conceptually as a single monolithic entity, memory 120 may be arranged as a hierarchy of caches and other memory devices. In some instances, a hierarchy of cache memories is associated with each CPU 106 and/or GPU 172. Memory 120 may include an operating system (OS) 122 and applications 124. Operating system 122 may provide functions such as device drivers or interfaces, management of memory pages, management of multiple tasks, etc., as is known in the art. Applications 124 may be programs, procedures, algorithms, routines, instructions, software, etc. that directs what tasks computer system 100 should accomplish and instructs how computer system 100 should accomplish those tasks. For example, an application 124 may for example utilize input data generated from input devices to determine if and when a hover section should be displayed via the GPU.

Host system bus 115 may support the transfer of data, commands, and other information between the host processor system 102 and other internal, peripheral, or external devices attached to it. Host system bus 115 may also support the communication of data between external devices independent of the host processor complex 102. While shown in simplified form as a single bus, the host system bus 115 may be structured as multiple buses which may be for example hierarchically arranged. Host system bus 115 may be connected to other internal host 102 components (such as a touch screen display 133, display 132, etc.) and/or to a myriad of external or peripheral devices through a connection hub 130, through an adapter 140, a multifunction adapter 150, or directly to a network 170.

In exemplary embodiments, the computer system 100 may be a mobile device that comprises one or more input devices, display 132, memory 120, etc. Input device(s) may be any system and/or device capable of receiving input from a user. Examples of input devices include, but are not limited to, a mouse or handheld device 136, a key board 134, a print scanner 138, a microphone, a touch screen 133, and the like input devices. In the various embodiments, each input device may be in communication with display 132. In one embodiment, display 132 includes touch screen 133 such that display 132 and the input device are integrated devices. In various embodiments, display 132 is configured to display an image generated by GPU 172 that received data from one or more input device(s). Further input devices may be any system and/or device capable of capturing environmental inputs (e.g., visual inputs, audio inputs, and tactile inputs). Examples of capture devices include, but are not limited to, a camera, a microphone, a global positioning system (GPS), a gyroscope, a plurality of accelerometers, etc.

Display 132 may be a cathode-ray tube display, a flat panel display, or other display technology. One or more adapters 140 may support keyboard 134 and mouse 136; it being understood that other forms of input devices could be used. The number and types of devices shown in FIG. 1 are illustrative only and ordinary users of computer systems now know that a great variety of connected devices exist; e.g., microphones, speakers, infrared remote controls, wireless connected devices, etc. and therefore computer system 100 is not limited to those devices illustrated in FIG. 1.

The host system bus 115 may also be connected to an adapter 140. Adapter 140 is an expansion device that may expand the functionalities of computer system 100. For example, adapter 140 may be an input output (I/O) adapter connected to an external memory device 144, a graphics adapter including graphics processing complex 170 that is connected to an external display 132, etc. External memory device 144 may be rotating magnetic disk storage, rotating or static optical drives, magnetic tape storage, FLASH memory, etc. Adapter 140 may include adapter microcode or firmware and decision logic which may be embodied as a message processor 142. The adapter 140 may also be provided with at least one fast nonvolatile write cache, queues, interrupt registers connected to the message processor 142 and/or decision logic. The message processor 142 may process incoming messages from the host processor complex 102 and generate and transmit response messages back to the host processor complex 102. The host system bus 115 may also be connected to a multifunction adapter 150 to which more I/O devices may be connected either directly, or through one or more bridge devices 160, or through another multifunction adapter 150 on either a primary bus 155 or a secondary bus 165.

Network interface 170 provides an operative connection for transmission of data to and from a network. The network may be an internet but could also be any smaller self-contained network such as an intranet, a WAN, a LAN, or other internal or external network using; e.g., telephone transmission lines, cable services, satellites, fiber optics, T1 lines, wireless, etc., and any other various technologies.

Computer system 100 need not be a computer at all, but may be a simpler device such as a network terminal, a thin client, a terminal-like device, a voice response unit, etc. The convergence of computing, telecommunications and consumer electronics is causing a tremendous growth in the number and variety of pervasive mobile devices as clients. This mobile architecture enables the multitude of client devices including laptops, sub-notebooks, handheld computers such as personal digital assistants and companion devices, and mobile appliances such as smart phones, pagers, simple messaging devices and wearable devices. Thus when the computer system 100 is a mobile device, adapters 140 and network interfaces 170 may support a variety of multi-modal interfaces input device interfaces such as those for keyboard 134 mouse 134, small text screens, pen, touch screens 133, speech recognition, text-to-speech, and/or wearable devices.

In certain embodiments some or all of the devices shown and described in FIG. 1 may be included in a discrete computer system 100 (e.g. touch screen display 133, memory device 144, etc. are included within computer system 100, etc.). In other embodiments some of the devices shown and described in FIG. 1 may be separate, peripheral, or external to computer system 100 (e.g. multiple modular computer systems 100 may share a single large database, external display 132 is peripherally connected to computer system 100, etc.). Further, the devices shown and described in FIG. 1 may each include hardware and/or software device drivers, interfaces, registers, buffers, or the like to allow for effective communication between devices.

The computer system shown in FIG. 1 is intended to be a simplified representation, it being understood that many variations in system configuration are possible in addition to those specifically mentioned here. For instance, though computer system 100 may be a portable device as described above, computer system 100 may also be a larger computer system such as a general purpose server.

Various embodiments of the present invention pertain to methods that may be implemented upon or by computer system 100. When computer system 100 performs particular tasks according to one or more methods described herein as is directed by at least one application 124, such computer system 100 becomes a special purpose computer particular to those one or more methods.

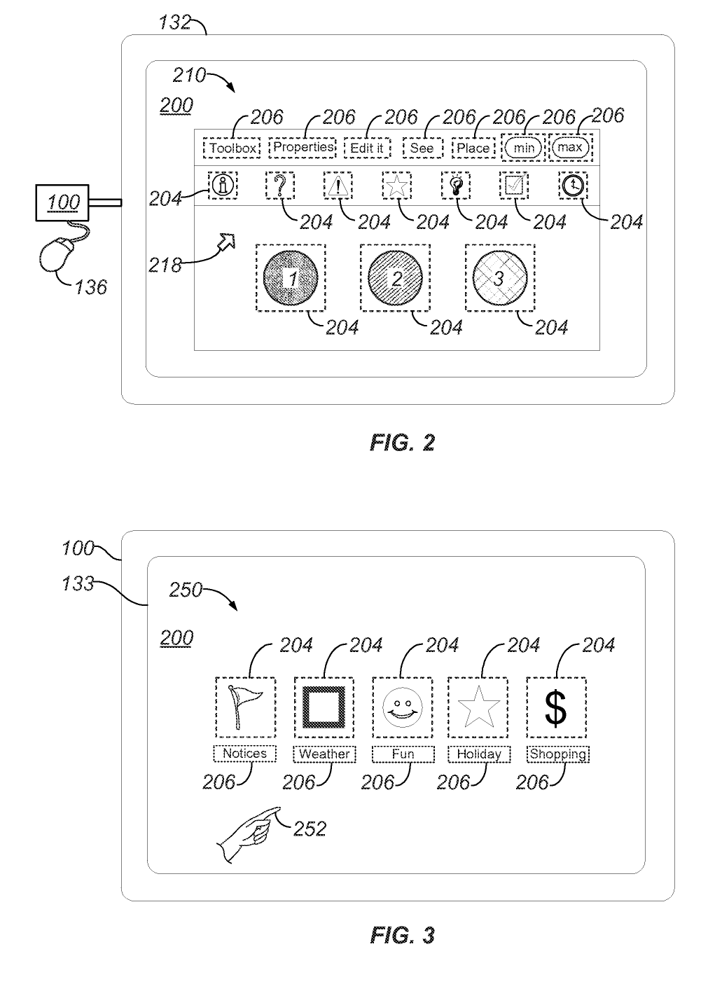

FIG. 2 and FIG. 3 illustrate exemplary GUIs 200, according to various embodiments of the present invention. GUI 200 may be generated by e.g. CPU 106 and/or GPU 172 working in conjunction with applications 124. GUI 200 provides a graphical interface that is displayed upon, for example, display 132, touch screen display 133, etc. The user may interact with GUI 200 to e.g. manage computer system 100, to manage one or more devices in computer system 100, to manage, control, develop, create, utilize etc. one or more applications 124, manage one or more devices connected to computer system 100, etc., it being understood that GUI 200 may be utilized to accomplish many other functions upon or via computer system 100.

GUI 200 may visually present actions available to the user enabling user to interact with computer system 100. The user may interact via GUI 200 in a variety of ways, but generally the user interacts with GUI 200 by engaging image objects 204, textual objects 206, etc. How a user engages an image object 204 depends upon, for example, the particular image object 204, hierarchies, associations, or relationships that exist between multiple image objects 204, rules as defined by an application 124 associated with image objects 204, etc.

As shown in FIG. 2, GUI 200 may be a WIMP interface 210 (window, icon, menu, pointing device). When using a WIMP interface 210, the user utilizes, for example, the mouse or other handheld device 136 to control the position of cursor 218. In certain embodiments, the WIMP interface 210 presents information in a window and an icon based environment. The user may engage a particular image object 204 or text object 206 by maneuvering the device 136 to manipulate cursor 218 to the particular object (e.g. “hover”, etc.). The user may further engage the device 136 (e.g. click, double click, etc.), etc.

As shown in FIG. 3, GUI 200 may be a gesture interface 250. Using gesture interface 250, the user may interact with computer system 100 by touching with one or more fingers 252 touch screen display 133. Exemplary touch gestures are pointing, pinching, flicking, rotating, etc. More generally, the user may engage a particular image object 204 or text object 206 by utilizing gesture interface 250 to engage with the particular image object 204 or text object 206. Gesture interface 250 may be beneficial when computer system 100 is a smaller mobile device such as a tablet, PDA, or smart phone, due to screen size constraints.

Applications 124 may display a GUI 200 having one or more image objects 204 and one or more text objects 206. GUIs 200 may include numerous views or pages that may include similar image objects 204 or text objects 206 relative to other pages. As such, typically there are numerous different image objects 204 and text objects 204 that the particular application 124 displays utilizing GUI 200 via the GPU 172.

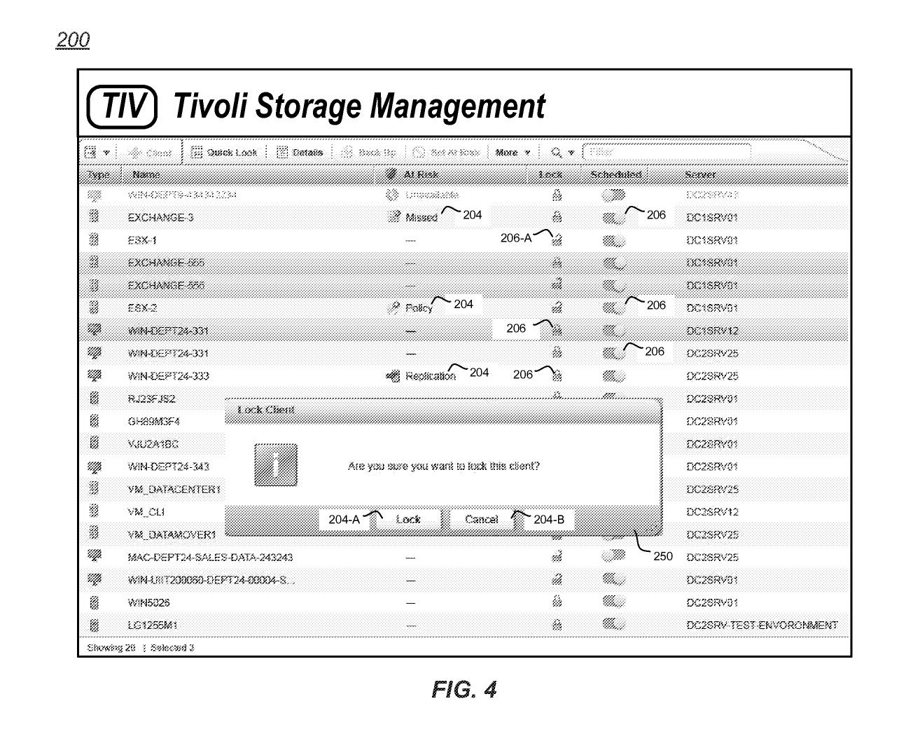

FIG. 4 illustrates an exemplary GUI 200 utilizing a user selection confirmation prompt. The GUI 200 shown in FIG. 4 includes various text objects 204 and image objects 206 that may be engaged by the GUI 200 user. The particular GUI 200 includes numerous rows associated with various resources that may be controlled via computer 100. Each resource row includes at least one image object 204 associated with enabling or disabling functionality associated with computer 100. For example, an image object 206-A is associated with locking or unlocking a particular resource “ESX-1.” To implement such function the user may engage the image object 206-A. Subsequent to the user engagement, a confirmation prompt 250 is displayed to ensure that the user's engagement of image object 206-A was intentional. The user may engage text object 204-A if the engagement of image object 206-A was intentional. Alternatively the user may engage text object 204-B if the engagement of image object 206-A was not intentional. Confirmation prompt 250 therefore imposes a penalty and increases time-on-task that increases the complexity of the GUI by requiring the user to read or engage more than necessary. Such overhead decreases the usability of the GUI by making it more difficult to use, less efficient by virtue of e.g. increased engagement actions, adds cognitive processing load by causing the user to have to take extra steps, etc. Such overhead is exponentially tedious in GUIs 200 like as shown in FIG. 4 that display numerous image objects 206 and text objects 206 that may each be engaged, etc.

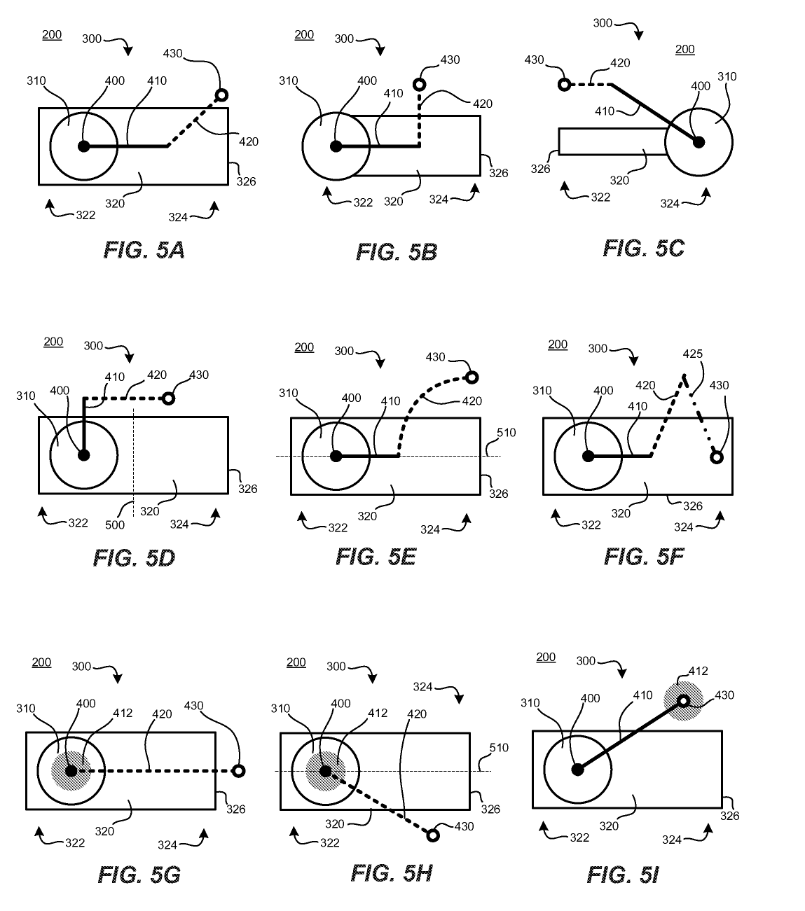

FIG. 5A-FIG. 5I each illustrate an exemplary toggle object 300. Toggle object 300 may be displayed by or otherwise utilized by a GUI 200 and is associated with binary functionality associated with computer system 100. For example, toggle object 300 may be included within GUI 200 to enable or disable a resource or function of computer system 100. Further, toggle object 300 may be included within GUI 200 to enable or disable a resource or function controlled by computer system 100.

Toggle object 300 includes a toggle button 310 that is movable between an active position 322 and an inactive position 324 within a barrier 326 of a slider section 320. When toggle button 310 is in the active position 322, functionality associated with the toggle object 300 is active and when toggle button 310 is in the inactive position 324 functionality associated with the toggle object 300 is inactive. The relative positioning of active position 322 and inactive position 324 may be reversed.

In some embodiments, as exemplarily shown in FIG. 5A, toggle button 310 may move within the barrier 326 of slider section 320. In other embodiments, as exemplarily shown in FIG. 5B and FIG. 5C, a portion of toggle button 310 may move within the barrier 326 of slider section 320. For example, a center point of toggle button 310 may move within the barrier 326.

Toggle object 300 is movable between active position 322 and inactive position 324 by an engagement capture 400 of toggle button 310, a first user manipulation 410, a second user manipulation 420, and an engagement release 430. For example, if a WIMP interface 210 includes toggle object 300, the user may manipulate cursor 218 within the area of toggle button 310 and engage (e.g. click, etc.) mouse or handheld device 136 for the engagement capture 400. The user may subsequently move cursor 218 by making the first user manipulation 410 and by making the second user manipulation 420. The user may subsequently disengage the mouse or handheld device 136 for the engagement release 430 upon which the toggle button 310 moves from active position 322 to inactive position 324, or visa versa.

In another example, if gesture interface 250 includes toggle object 300, the user may contact touch screen 133 with a finger 252 within the area of toggle button 310 for the engagement capture 400. The user may drag finger 252 for the first user manipulation 410 and for the second user manipulation 420. The user may subsequently move finger 252 away from touch screen 133 for the engagement release 430 upon which the toggle button 310 moves from active position 322 to inactive position 324, or visa versa.

In embodiments, the multi-manipulation (e.g. first user manipulation 410, second user manipulation 420, etc.) is indicative of the user's intent by including at least one manipulation beyond user selection or engagement. For example, the combination of the user manipulations indicate the user's intent and confirmation to activate (or deactivate) functionality associated with the toggle object 300. In embodiments, the manipulations are indicative of the user's intent and confirmation if the relative angle between the second user manipulation 420 and the first user manipulation 410 is greater or less than a threshold angle. For example, it may be inferred that the user's intent is to activate and confirm functionality associated with the toggle object 300 if the relative angle between the second user manipulation 420 and the first user manipulation 410 is less than 130 degrees, etc. In certain embodiments, the presence of the second user manipulation 420 in and of itself is indicative of the user's intent.

In embodiments, like that shown in FIG. 5A, the relative angle between first user manipulation 410 and second user manipulation 420 is obtuse but less than 180 degrees. In other embodiments, the relative angle between first user manipulation 410 and second user manipulation 420 is acute. In embodiments, like that shown in FIG. 5B, user manipulation 410 and second user manipulation 420 may be substantially perpendicular (e.g. 90 degrees plus or minus 5 degrees, etc.).

In certain embodiments, like that shown in FIG. 5D, the manipulations are indicative of the user's intent and confirmation if the engagement release 430 occurs distally past a vertical axis 500 of slider section 320 relative to the current positioning of toggle button 310. In certain embodiments, like that shown in FIG. 5E, the engagement release 430 may occur above horizontal axis 510 of slider section 320. In other embodiments, like that shown in FIG. 5H, the engagement release 430 may occur below horizontal axis 510 of slider section 320. In certain embodiments, the engagement manipulations are indicative of the user's intent and confirmation if the engagement release 430 occurs exterior to the barrier 326. In certain embodiments, the first user manipulation 410 and/or second user manipulation 420 may first occur within barrier 326 and subsequently occur exterior to barrier 326. In embodiments, like that shown in FIG>5F, the engagement release 430 may occur within barrier 326.

In certain embodiments, like that shown in FIG. 5E, one or more of the manipulations may be curved, arced, etc. In embodiments, like that shown in FIG. 5F, the muli-manipulation may include a third manipulation 425. For example, the user may contact touch screen 133 with a finger 252 within the area of toggle button 310 for the engagement capture 400. The user may drag finger 252 for the first user manipulation 410, for the second user manipulation 420, and for the third user manipulation 425. The user may subsequently move finger 252 away from touch screen 133 for the engagement release 430.

In certain embodiments, like those shown in FIG. 5G-FIG. 5I, object 300 is movable between active position 322 and inactive position 324 by an engagement capture 400 of toggle button 310, a user pause manipulation 412, a first user manipulation 420, and an engagement release 430. For example, if a WIMP interface 210 includes toggle object 300, the user may manipulate cursor 218 within the area of toggle button 310 and engage mouse or handheld device 136 for the engagement capture 400. The user may pause or make no further manipulations for a predetermined time (e.g. 3 seconds, etc.) for the user pause manipulation 412 and the user may subsequently move cursor 218 to make the first user manipulation 410. The user may subsequently disengage the mouse or handheld device 136 for the engagement release 430 upon which the toggle button 310 moves from active position 322 to inactive position 324, or visa versa.

In certain embodiments, like that shown in FIG. SI, the pause manipulation 412 may occur subsequent to the first manipulation 410. For example, if gesture interface 250 includes toggle object 300, the user may contact touch screen 133 with a finger 252 within the area of toggle button 310 for the engagement capture 400. The user may drag finger 252 for the first user manipulation 410 and subsequently the user may pause or make no further manipulations for a predetermined time for the user pause manipulation 412. The user may move finger 252 away from touch screen 133 for the engagement release 430 upon which the toggle button 310 moves from active position 322 to inactive position 324, or visa versa.

In embodiments, various combinations of first user manipulation 410, second user manipulation 420, third user manipulation 425, and/or user pause manipulation 412 may be utilized by toggle object 300. For example, the toggle object may utilize a first pause manipulation 412, a first user manipulation 410, a second user manipulation 420, and a second pause manipulation 412 to move toggle button 310 from active position 322 to inactive position 324, or visa versa.

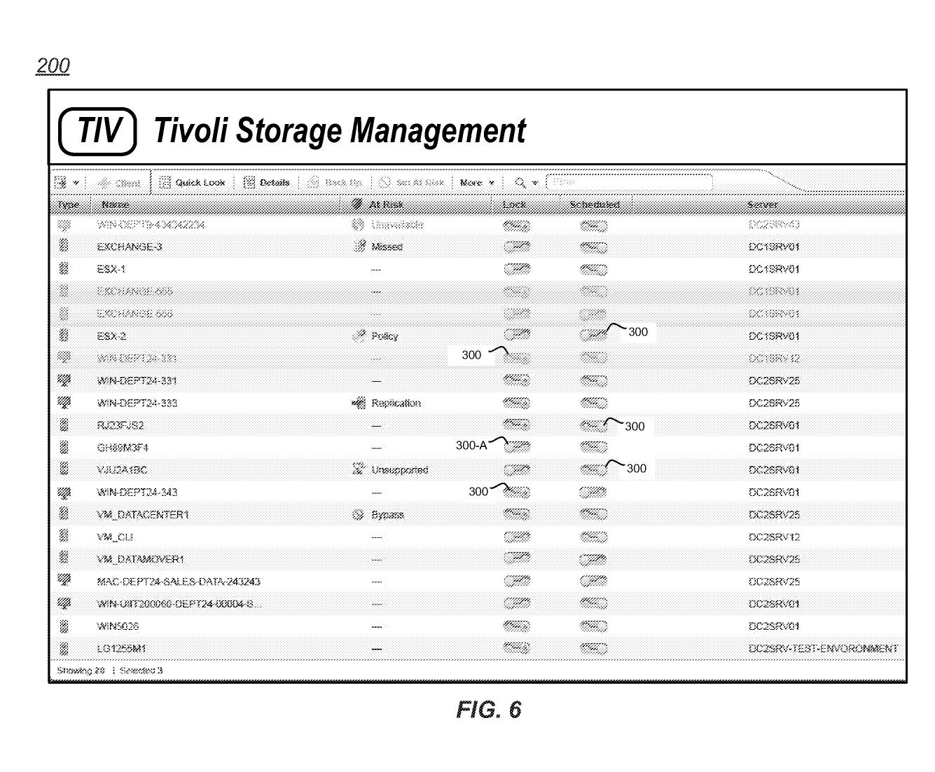

FIG. 6 illustrates an exemplary GUI 200 utilizing toggle object 300. The GUI 200 shown in FIG. 6 may further include various text objects 204 and image objects 206 that may be engaged by the GUI 200 user. The particular GUI 200 includes numerous rows associated with various resources that may be controlled via computer 100. Each resource row includes at least one toggle object 300 with enabling or disabling functionality associated with computer 100. For example, a toggle object 300-A is associated with locking or unlocking a particular resource “GH89M3F4.” To lock such resource, the user makes a multi manipulation upon the toggle object 300 according to one or more embodiments described herein. Upon the toggle head 310 moving to active position 322 the resource is locked. As such, toggle object 300-A decreases time-on-task and simplifies the GUI 200 by reducing the number of user interactions necessary to implement functions according to the user's intent. In other words, the multi manipulation necessary to move the toggle button 310 to/from active position 322 from/to inactive position 324 is indicative of the user's intent to do so. Since the multi manipulation is indicative of intent, in embodiments, GUI 200 need not display confirmation prompt 250 to confirm user's intent. In this way, user experience of GUI 200 including toggle graphic object 300 is improved.

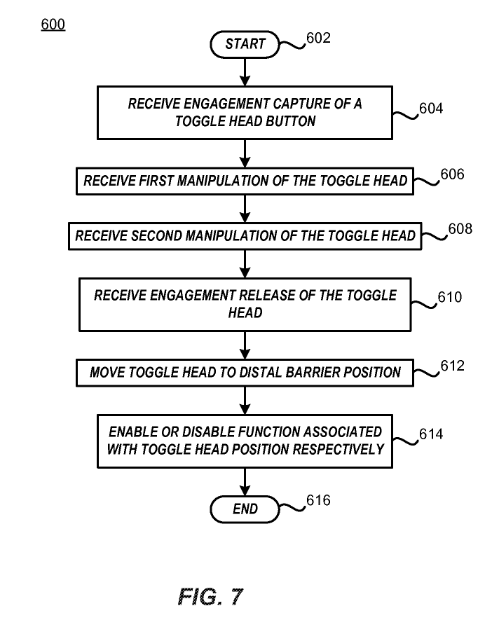

FIG. 7 illustrates an exemplary method 600 for enabling or disabling data handling system functionality controlled via a GUI 200. Method 600 may be utilized by e.g. a computer system 100 that displays a GUI that includes one or more toggle objects 300 used to enable or disable functionality of computer system 100 or enable or disable functionality that is controlled by computer system 100.

Method 600 begins at block 602 and continues with data handling system receiving an engagement capture 400 of toggle button 310 of toggle object 300 (block 604). For example, in a gesture interface 250, a computer system 100 may receive a user's contact of touch screen 133 with finger 252 within the area of toggle button 310.

Method 600 may continue by data handling system receiving an first user manipulation 410 of the toggle button 310 (block 606). For example, the user may drag finger 252 upon touch screen 133. Method 600 may continue by data handling system receiving a second user manipulation 420 of the toggle button 310 (block 608). For example, the user may continue to drag finger 252 upon touch screen 133 in a generally differing direction.

Method 600 may continue with data handling system receiving an engagement release 430 of the toggle button 310 (block 610). For example, the user may subsequently move finger 252 away from touch screen 133. The location at which the engagement release 430 is received may be interior or exterior to barrier 325 of slider section 320.

Method 600 may continue with moving or sliding the toggle button 310 from active position 322 to inactive position 324 within slider section 320 or visa versa (block 612). For example, toggle button 310 is moved from inactive position 324 to active position 322. Method 600 may continue by enabling or disabling functionality of computer system 100 or enabling or disabling functionality associated with the toggle object. Method 616 ends at block 616.

Embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the FIGs. illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method for enabling or disabling data handling system functionality controlled via a graphical user interface (GUI), the method comprising:
receiving a user engagement capture of a toggle object displayed upon the GUI;
receiving a multiple stage user manipulation of the toggle object indicative of the users intent to enable or disable associated data handling system functionality, and;
enabling or disabling associated data handing system.

2. The method of claim 1 wherein the toggle object comprises a toggle button movable between an active position and an inactive position within a sliding section comprising a barrier.

3. The method of claim 2, wherein the multiple stage user movement manipulation comprises a first user movement manipulation of the toggle button in a first direction and a second user movement manipulation of the toggle button in a second direction.

4. The method of claim 2, wherein the multiple stage user movement manipulation comprises a first user movement manipulation of the toggle button in a first direction and a user pause manipulation of the toggle button.

5. The method of claim 1 wherein the user engagement capture comprises a user touching the toggle object upon a touch screen display and wherein the multiple stage user movement manipulation comprises the user dragging the toggle object upon the touch screen.

6. The method of claim 1 wherein the user engagement capture comprises a user moving a cursor displayed upon the GUI and selecting the toggle object and wherein the multiple stage user movement manipulation comprises the user dragging the selected toggle object by moving the cursor.

7. The method of claim 2, further comprising:
receiving an engagement release of the toggle object.

8. The method of claim 7 wherein the location of the release of the toggle object is interior to the barrier.

9. The method of claim 7 wherein the location of the release of the toggle object is exterior to the barrier.

10. A computer program product for enabling or disabling data handling system functionality controlled via a graphical user interface (GUI), the computer program product comprising a computer readable storage medium having program instructions embodied therewith, the program instructions readable by a computer to cause the computer to:
receive a user engagement capture of a toggle object displayed upon the GUI;
receive a multiple stage user manipulation of the toggle object indicative of the users intent to enable or disable associated data handling system functionality, and;
enable or disable functionality associated data handing system.

11. The computer program product of claim 10, wherein the toggle object comprises a toggle button movable between an active position and an inactive position within a sliding section comprising a barrier.

12. The computer program product of claim 11, wherein the multiple stage user movement manipulation comprises a first user movement manipulation of the toggle button in a first direction and a second user movement manipulation of the toggle button in a second direction.

13. The computer program product of claim 11, wherein the multiple stage user movement manipulation comprises a first user movement manipulation of the toggle button in a first direction and a user pause manipulation of the toggle button.

14. The computer program product of claim 10, wherein the user engagement capture comprises a user touching the toggle object upon a touch screen display and wherein the multiple stage user movement manipulation comprises the user dragging the toggle object upon the touch screen.

15. The computer program product of claim 10, wherein the user engagement capture comprises a user moving a cursor displayed upon the GUI and selecting the toggle object and wherein the multiple stage user movement manipulation comprises the user dragging the selected toggle object by moving the cursor.

16. The computer program product of claim 11, wherein the program instruction further cause the computer to:
receive an engagement release of the toggle object.

17. The computer program product of claim 16, wherein the location of the release of the toggle object is interior to the barrier.

18. The computer program product of claim 16, wherein the location of the release of the toggle object is exterior to the barrier.

19. A graphical user interface (GUI) utilized to enable or disable functionality of a data handling system, the GUI comprising:
a toggle object comprising a toggle button movable between an active position and an inactive position within a sliding section barrier by the GUI receiving a engagement capture of the toggle button, receiving a multiple stage user manipulation of the toggle button indicative of the users intent to enable or disable associated functionality, and receiving a engagement release of the toggle button to enable or disable functionality of the data handing system.

20. The method of claim 19 wherein the location of the engagement release of the toggle button is exterior to the sliding section barrier.
